(19) United States
(12) Patent Application Publication
(10) Pub. No.: US 2004/0239799 A1
(43) Pub. Date: Dec. 2, 2004

(54) Electronic device with camera

(75) Inventors: Naoto Suzuki, Tokyo (JP); Akira Moriya, Tokyo (JP)

Correspondence Address: MCGINN & GIBB, PLLC, 8321 OLD COURTHOUSE ROAD, SUITE 200, VIENNA, VA, 22182-3817, US

(73) Assignee: Tohoku Pioneer Coporation, Tendo-shi (JP)

(21) Appl. No.: 10/852,998

(22) Filed: May 25, 2004

(30) Foreign Application Priority Data
May 26, 2003 (JP) 2003-147687

(51) Int. Cl. H04N 5/222

(52) U.S. Cl. 348/370

(57) ABSTRACT

A display portion of a camera-equipped electronic device has a display screen on the same side as a lens portion of a camera unit. The display portion includes an input portion enabled with a signal from a main control unit, an image storage portion and a register for receiving a signal from the input portion, a display control portion, a drive portion, and a display panel having the display screen. With this configuration, the display control portion provides control to the functions of the display panel to be switched between a normal display function and an illuminating function for use with the camera unit. Thus, in the camera-equipped electronic device, the display portion having the illuminating function for use in photographing can provide good images in self photographing and supports for a more compact device body while ensuring high visibility and capability of displaying an increased amount of information.

### BACKGROUND OF THE INVENTION

The present invention relates to a camera-equipped electronic device which includes a camera unit and at least one display portion.

The present application claims priority from Japanese Patent Application No.2003-147687, the disclosure of which is incorporated herein by reference.

Recently, with reduction in size and increase in pixel density of solid-state image pickup elements, digital cameras or digital video cameras which process captured images in the form of digital data have become popular, leading to the development of various types of camera-equipped electronic devices or mobile electronic devices equipped with a camera unit. These camera-equipped electronic devices, including such a digital camera and a digital video camera, are basically designed to have a display portion for displaying captured images or information on photographing as well as a camera unit comprising solid-state image pickup elements such as CCD or CMOS.

This camera-equipped electronic device is often used to capture user's own images (the self-photographing with the user as a subject) In particular, a type of the device or a camera-equipped mobile phone is typically used to send user's own face images to the receiver along with user's voice. Thus, there is a critical need for the user to be able to photograph while checking user's own face images and photographing information. A camera-equipped mobile phone proposed in Japanese Patent Application Laid-Open No.2001-320454 incorporates an electronic camera (camera unit) and a liquid crystal display (display portion) for displaying captured still images of a subject, in which the taking lens of the electronic camera, the liquid crystal display, and a strobe are positioned on the front of the device body.

In the aforementioned camera-equipped electronic device, the camera unit is naturally required to be small in size and high in performance; however, the display portion tends to be required to have as large display screen as possible from the viewpoints of high visibility and an increase in the amount of information to be displayed. On the other hand, a camera unit reduced in size would have a reduced numerical aperture; however, since the camera unit needs to properly operate in service environments such as indoors or at night, it is inevitable to equip the camera unit with an illuminating apparatus for use with photographing in order to provide good images.

Under these circumstances, the mobile electronic device is required to have a more compact device body. To provide a camera-equipped electronic device which enables a good self-photographing, it has become critical to wrestle with a problem of how to place the three components or the lens portion of the camera unit, the display screen of the display portion, and the illuminating apparatus for photographing use, on the same side with higher degrees of efficiency.

### SUMMARY OF THE INVENTION

An aspect of the present invention is to address such a problem. It is therefore an object of the invention to provide a camera-equipped electronic device which includes a camera unit and at least one display portion, in which the display portion has an illuminating function for use in photographing, and provides good images in self-photographing and supports for a more compact device body while ensuring high visibility and capability of displaying an increased amount of information.

To achieve the aforementioned object, the camera-equipped electronic device of the present invention is configured at least as set forth in the following aspect.

According to one aspect of the present invention, a camera-equipped electronic device including a camera unit having a lens portion and at least one display portion having a display screen is provided, wherein the lens portion of the camera unit and the display screen of the display portion can be disposed on the same side of the device, and further the display portion can be controllably switched between a display function and an illuminating function for illuminating a subject for use with camera unit.

### BRIEF DESCRIPTION OF THE DRAWINGS

These and other objects and advantages of the present invention will become clear from the following description with reference to the accompanying drawings, wherein:

FIG. 1 is an explanatory view illustrating the outer arrangement of a camera-equipped electronic device according to an embodiment of the present invention;

FIG. 2 is an explanatory view illustrating an exemplary configuration of a display portion of a camera-equipped electronic device according to an embodiment of the present invention;

FIG. 3 is an explanatory view illustrating another exemplary configuration of a display portion of a camera-equipped electronic device according to another embodiment of the present invention;

FIGS. 4A and 4B are explanatory views illustrating an example (camera-equipped mobile phone) according to the present invention;

FIG. 5 is an explanatory flowchart showing an exemplary photographing procedure according to an example of the present invention;

FIGS. 6A and 6B are explanatory views illustrating an example (camera-equipped mobile phone) according to the present invention;

FIGS. 7A and 7B are explanatory view illustrating an example (camera-equipped mobile phone) according to the present invention; and

FIGS. 8A and 8B are explanatory view illustrating an example (digital camera) according to the present invention.

### DETAILED DESCRIPTION OF THE PREFERRED EMBODIMENTS

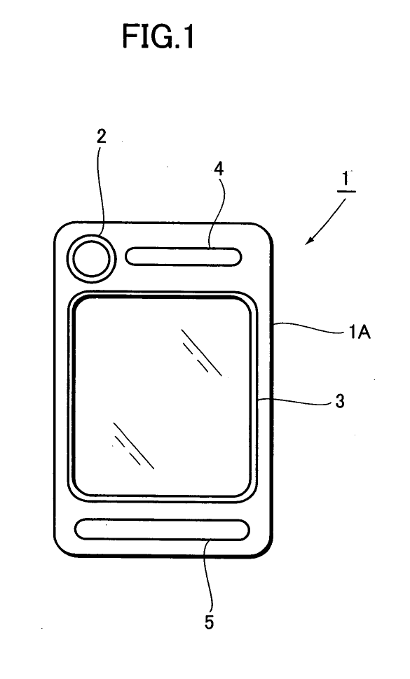

Now, the present invention will be described below with reference to the drawings in accordance with the embodiments. FIG. 1 is an explanatory view illustrating the outer arrangement of a camera-equipped electronic device according to an embodiment of the present invention. The camera-equipped electronic device 1 includes a lens portion 2 of a camera unit and a display screen 3 of a display portion, both of which are disposed on the same side of the device body 1A. The camera unit includes solid-state image pickup elements such as CCD or CMOS for storing and delivering electronic image information. The display portion functions to display various types of display information and image information captured by the camera unit on the display screen. This configuration may also include a plurality of display portions and display screens, at least one of the display screens thereof being provided on the same side as the lens portion 2, or alternatively a main display portion and a sub-display portion, either one of the display screens thereof being provided on the same side as the lens portion 2. On the other hand, the device body 1A is provided, as required, with input and output portions 4, 5 such as a loudspeaker, a microphone, or control switches. The camera-equipped electronic device 1 is not limited to a particular type as long as it is configured as described above. Embodiments of the present invention may include various devices such as a digital camera, a digital video camera, a camera-equipped mobilephone, a camera-equipped mobile information terminal (such as personal digital assistant called as PDA), or a camera-equipped mobile personal computer.

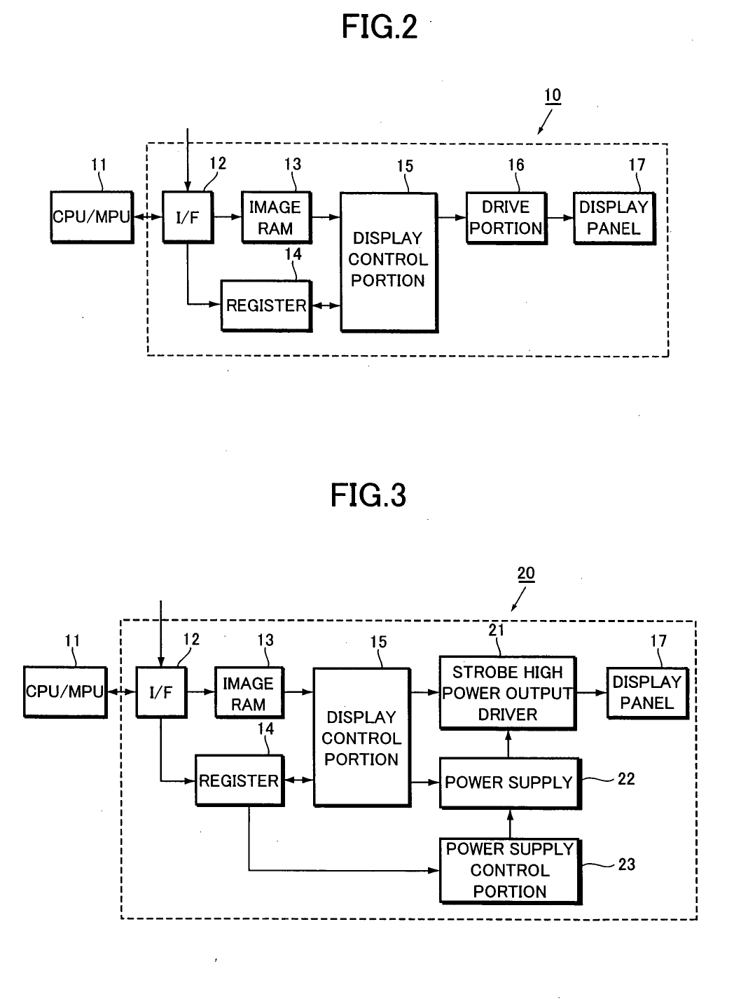

FIG. 2 is an explanatory view illustrating an exemplary configuration of the aforementioned display portion. The display portion 10 includes an input portion 12 enabled with a signal from a main control unit 11, an image storage portion (image RAM) 13 and a register 14 for receiving a signal from the input portion 12, a display control portion 15, a drive portion 16, and a display panel 17 having the display screen 3. With this configuration, the display control portion 15 provides control to the functions of the display panel 17 to be switched between the display function and the illuminating function for use with the camera unit.

The display function of the display panel 17 which can be selected includes a finder function of the camera unit, a function for displaying the photographing information which is displayed in response to the photographing operation of the camera unit, and among other things, a function for displaying countdown information for signaling the start of photographing with the camera unit. On the other hand, the illuminating function which can be selected includes a light or lighting function for illuminating a subject, and a flash or flashing function enabled immediately before the start of photographing with the camera unit. The operation of the display portion for each of these functions will be described below.

a. Finder function: When the finder function is selected on the display control portion 15, the image data supplied by the camera unit to the input portion 12 is temporarily stored in the image storage portion 13. When a command for displaying the image is supplied to the register 14, the stored image data is sent to the drive portion 16. In response to the image data, the drive portion 16 sends a drive signal to the display panel 17, so that the captured image from the camera unit is displayed on the display screen of the display panel 17.

b. Photographing information display function: When the main control unit 11 supplies a photographing operation signal to the register 14, a photographing information signal to be stored in a memory of the display control portion 15 is delivered to the drive portion 16. In response to the photographing information signal, the drive portion 16 sends the drive signal to the display panel 17, so that the photographing information is displayed on the display screen of the display panel 17. In particular, to display countdown information for signaling the start of photographing with the camera unit, the display control portion 15 sends countdown information to the drive portion 16 in response to a shutter release signal and a timer signal which are sent from the main control unit 11, so that the countdown information is displayed on the display panel 17.

c. Light function: When an instruction signal is sent to the register 14 from the main control unit 11, the display control portion 15 selects the light function, such that a screenful of image data of “white” is sent to the drive portion 16. In response to the image data, the drive portion 16 sends a drive signal to the display panel 17, so that the display screen of the display panel 17 emits white light. If the display panel 17 can display in colors, it is also possible to provide illumination in other colors as well as white light.

d. Flash function: When an instruction signal is sent to the register 14 from the main control unit 11, the display control portion 15 selects the flash function, so that a screenful of image data of “white” is sent to the drive portion 16 and then instantaneously stopped. This allows the display screen of the display panel 17 to emit white light momentarily. If the display panel 17 can display in colors, it is also possible to provide illumination in other colors as well as white light.

With the flash function, to provide an instantaneous emission at high intensity, it is possible to employ the configuration of the display portion as shown in FIG. 3. In FIG. 3, the same components as those of FIG. 2 are indicated with like reference numerals and will not be repeatedly explained. The display portion 20 is different from the aforementioned display portion 10 in that the display portion 20 includes a high power output driver 21 for strobe use, a power supply 22 for generating high voltages, and its power supply control portion 23, instead of the drive portion 16. With this configuration, when the register 14 receives an instruction, the power supply control portion 23 starts to operate causing the power supply 22 to generate a high voltage therein. Thereafter, when a sufficiently high voltage is achieved in the power supply 22, the high power output driver 21 for strobe use applies the high voltage to the display panel 17 in response to a flash function command.

Now, the display panel 17 will be described below. It is possible to employ any type of flat display panels for use as the display panel 17; however, a self-emissive display panel is preferably used to effectively provide optical output upon selection of the illuminating function. On the other hand, an organic electroluminescent (EL) panel is preferably used to display in colors upon selection of the display function thereby permitting selection of emission in various colors upon selection of the illuminating function. In particular, to permit display of a large amount of information, a dot matrix organic EL display panel is preferably employed.

It is possible to employ conventionally well-known structures and materials so as to form the organic EL panel itself which is employed for this purpose. In general, the organic EL panel has organic EL devise formed on a substrate, each of which has an organic layer, including an organic luminescent layer, sandwiched between a pair of electrodes, with one of the electrodes formed of a transparent electrode. The aforementioned organic luminescent layer is typically a combination of a hole transport layer, an emission layer, and an electron transport layer. However, the emission layer, the hole transport layer, and the electron transport layer may be formed each in one layer or a stack of layers, while either one or both of the hole transport layer and the electron transport layer can be eliminated. On the other hand, an organic layer such as a hole injection layer or an electron injection layer may also be incorporated as required.

The organic EL panel may be designed to emit either a single color or two or more colors; however, it is necessary to employ an organic EL panel which emits two or more colors for display in colors as described above. For example, the organic EL panel which emits a plurality of colors can be formed according to one of the following techniques: a multi-color patterning technique for forming emission functioning layers of two or more colors including a method for forming three types of emission functioning layers each corresponding to R, G, and B; a CF or CCM technique employing a combination of an emission functioning layer of a single color such as white or blue and a color changing layer formed of a color filter or a fluorescent material; and a photo-bleaching technique for illuminating the emission area of a single-color emission functioning layer with electromagnetic waves to provide multiple emissions. The organic EL panel can be driven either by the passive or active drive method, and may provide emission through either the substrate (the bottom emission structure) or the side opposite to the substrate (the top emission structure).

In summary, the embodiments of the present invention provide the following aspects.

A first aspect relates to a camera-equipped electronic device including a camera unit having a lens portion and at least one display portion having a display screen, wherein the lens portion of the camera unit and the display screen of the display portion can be disposed on the same side of the device, the display portion being controllably switched between a display function and an illuminating function for illuminating a subject for use with camera unit. This makes it possible to provide good self-photographing for the user using illumination during the photographing while allowing the user to check the photographing information or the subject image on the display screen of the display portion, thus providing satisfactory self-photographing. Furthermore, the single display portion can serve as both the display function and the illuminating function, thereby eliminating a space which would be otherwise required for the installation of a separate illuminating apparatus. It is thus possible to efficiently place the lens portion of the camera unit and the display screen of the display portion on one side of the compact device body.

In conjunction with the aforementioned aspect, a second aspect relates to the display function of the display portion which serves as a finder for the camera unit. This allows the user to check the condition of the user's own face upon self-photographing to reduce unsatisfactory shootings, thereby providing satisfactory photographing to the user.

In conjunction with the aforementioned aspects, a third aspect relates to the display function of the display portion which serves as a function for displaying of photographing information which is displayed in response to photographing operation of the camera unit. This allows the user to check various pieces of photographing information upon photographing to reduce unsatisfactory shootings, thereby providing satisfactory photographing to the user.

In conjunction with the aforementioned aspects, a fourth aspect relates to the displaying of countdown information as the photographing information for signaling the start of photographing with the camera unit. Upon capturing a still image during self-photographing, the user can move his line of sight from the display screen to the lens portion of the camera unit immediately before the start of the photographing while checking the countdown information. This allows the camera to capture the front image of the user's face with a facial expression which pleases the user.

In conjunction with the aforementioned aspects, a fifth aspect relates to the illuminating function of the display portion which serves as a flash illumination function which is enabled immediately before the start of photographing with the camera unit. This allows for capturing good still images even under shooting circumstances in poor illumination such as indoors or at night.

In conjunction with the aforementioned aspects, a sixth aspect relates to the display portion being capable of selecting an emitted color for illumination. For example, this allows for providing a warm impression for a captured image using a red emission or a cool impression using a blue emission, thus providing additional variations to the special effects of the photographing illumination.

A seventh aspect relates to the display portion being formed of an organic EL panel. This allows for providing efficient emission and a sufficient amount of illumination during the illuminating function as well as facilitating switching from the display function to the illuminating function. Additionally, the organic EL panel emitting a plurality of colors allows color display and illumination with each of the colors, thus providing improved functions. Furthermore, the organic EL panel employing a flexible substrate provides a display screen which can be effectively formed on a curved device body.

An eighth aspect relates to the aforementioned camera-equipped electronic device being incorporated into an apparatus which also serves as a mobile phone. This allows for providing the aforementioned effective aspects to the mobile phone.

The camera-equipped electronic device according to the embodiments of the present invention may capture either still images or moving images. Furthermore, the aforementioned embodiments are based on the specific arrangement in which the lens portion of the camera unit and the display screen of the display portion are placed on the same side. However, devices with an orientation-switchable or removable lens portion of the camera unit may also be acceptable as long as their lens portion and display screen are disposed on the same side ultimately upon photographing.

### EXAMPLES

Now, by way of example, the present invention will be further described in accordance with the examples which employ a camera-equipped mobile phone or a digital camera; however, the present invention is not limited thereto. These examples also include a display portion having a main display screen and a sub display screen; however, the display screen of the present invention is not limited thereto.

### Example 1

### Camera-Equipped Mobile Phone

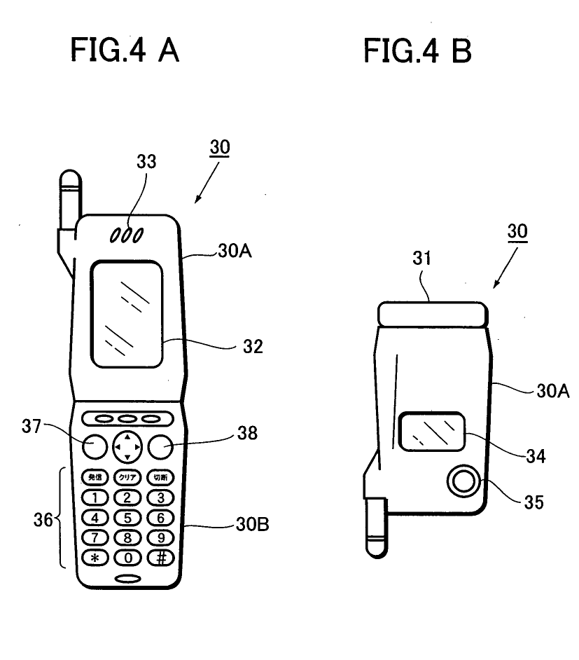

FIGS. 4A and 4B are explanatory views illustrating the outer arrangement of a camera-equipped mobile phone 30 according to an example of the present invention. In FIGS. 4A and 4B, illustrated is a folding mobile phone; FIG. 4A showing the phone in the expanded form and FIG. 4B showing the phone in the folded form. The camera-equipped mobile phone 30 includes a first body 30A and a second body 30B which are coupled to each other by a hinge 31. The first body 30A has a main display screen 32 of the display screen and a speaker opening 33, which are mounted on one side, and a sub display screen 34 of the display portion and a lens portion 35 of a camera unit, which are mounted on the other side. On the other hand, the second body 30B has a basic control portion 36, a mode switching button 37, a shutter button 38 and so on.

An aspect of Example 1 relates to the lens portion 35 of the camera unit and the sub display screen 34 of the display portion being disposed on the same side, in which the display portion of the sub display screen 34 is controllably switched between the display function and the illuminating function. On the other hand, the main display screen 32 may also be provided with the same function allowing the lens portion 35 to be movable. Any configuration may well do as long as the lens portion 35 and the display portion (i.e., the main display screen 32 or the sub display screen 34) are on the same side upon photographing.

As described in the aforementioned embodiments, the camera unit includes solid-state image pickup elements such as CCD or CMOS to store or output captured images. The display portion, as also described in the aforementioned embodiments, can employ any type of flat display panels as the display panels for the main display screen 32 and the sub display screen 34, with a main display portion corresponding to the main display screen 32 and a sub display portion corresponding to the sub display screen 34. The main display portion displays various pieces of information in response to the use of the mobile phone in the normal mode, while displaying a subject image in the camera mode of operation (finder function).

FIG. 5 is an explanatory flowchart of an exemplary procedure by which the camera-equipped mobile phone 30 captures images according to an example of the present invention. First, the mode switching button 37 or the like is depressed to select the photographing mode (S1). This causes the display portion to display a subject image on the main display screen 32 and the sub display screen 34 (S2). Upon self-photographing, the user strikes a pose while viewing the subject image appearing on the sub display screen 34 located on the same side as the lens portion 35 of the camera unit. When the shutter button 38 is depressed (S3), the sub display screen 34 is switched over to display the countdown information (S4). The sub display portion is switched to the flash function immediately before the start of the photographing operation, thereby allowing the sub display screen 34 to fire a flash (S5). The photographing is then completed (S6).

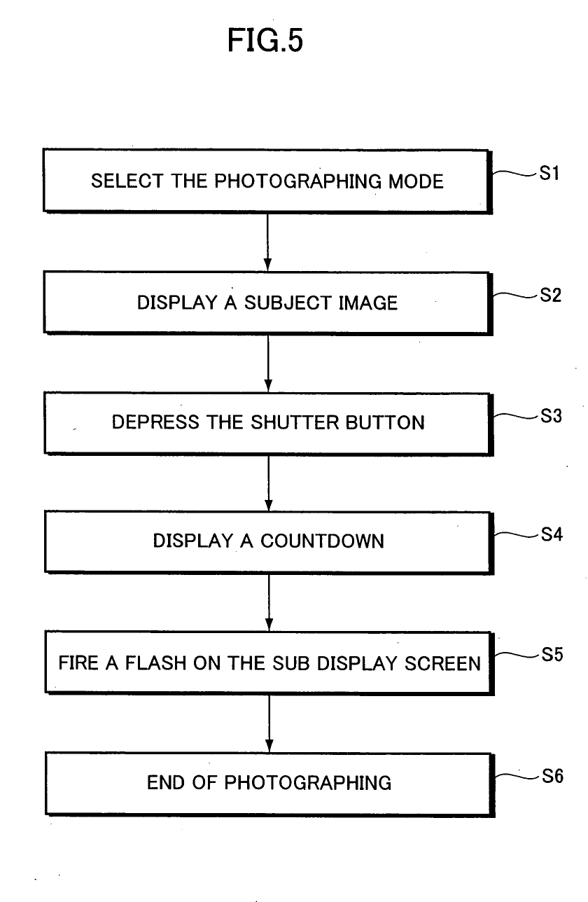

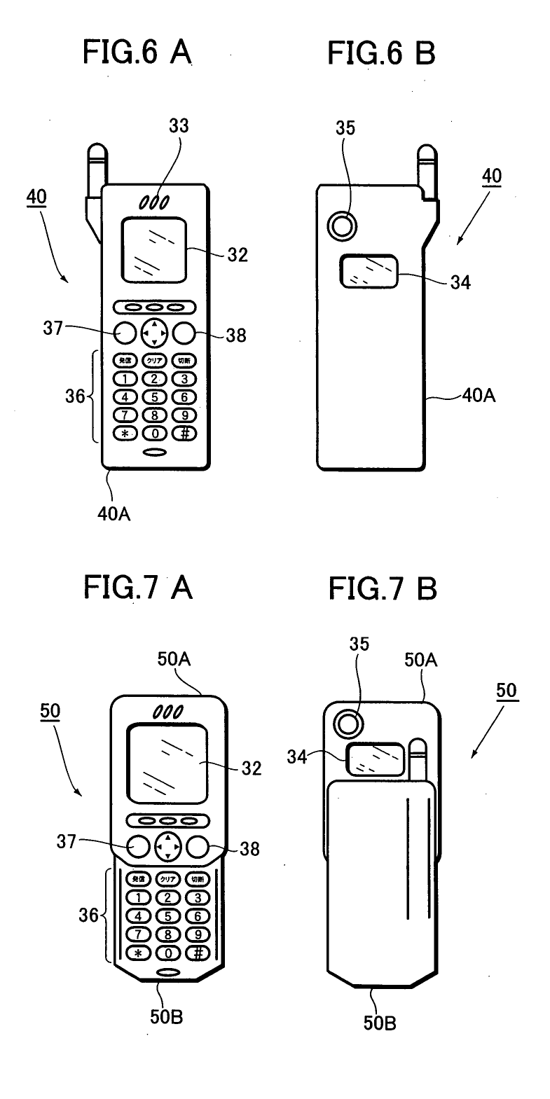

As the camera-equipped mobile phone, it is possible to employ not only the aforementioned folding phone but also any type of phone; e.g., a one-piece phone shown in FIG. 6 or a slidable phone shown in FIG. 7. The one-piece camera-equipped mobile phone 40 shown in FIGS. 6A and 6B includes the lens portion 35 of the camera unit and the sub display screen 34 on the back of the main body 40A (FIG. 6A shows one side and FIG. 6B shows the other side. The same components as those of FIGS. 4A and 4B are indicated with like reference numerals and will not be repeatedly explained here). The slidable camera-equipped mobile phone 50 shown in FIGS. 7A and 7B includes a first body 50A and a second body 50B which are slidably coupled in parallel to each other with the lens portion 35 of the camera unit and the sub display screen 34 located on the back of the first main body 50A (FIG. 7A shows one side and FIG. 7B shows the other side. The same components as those of FIGS. 4A and 4B are indicated with like reference numerals and will not be repeatedly explained.)

### Example 2

### Digital Camera

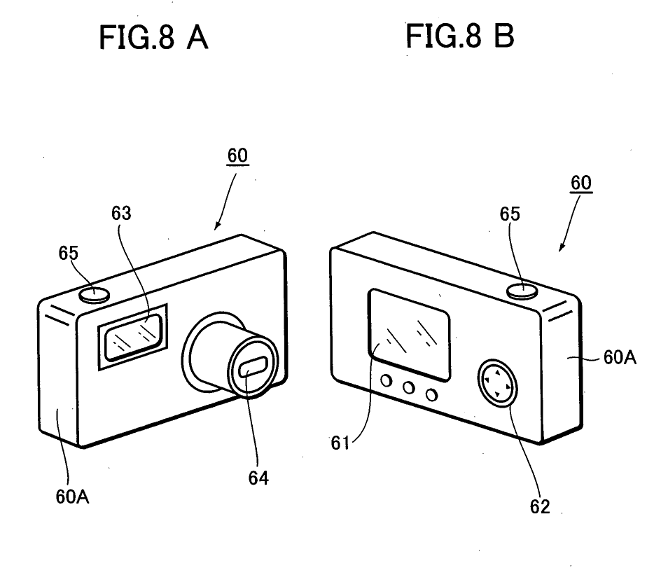

FIGS. 8A and 8B are explanatory views illustrating the outer arrangement of a digital camera 60 according to an example of the present invention. FIG. 8A is a front perspective view and FIG. 8B is a rear perspective view. The digital camera 60 includes a main display screen 61 of the display portion or a control portion 62, which are mounted on the back of the main body 60A, and a sub display screen 63 of the display portion and a lens portion 64 of the camera unit, which are mounted on the front. Also mounted on a side of the main body 60A are a shutter button 65 and so on.

An aspect of this configuration relates to the lens portion 64 of the camera unit and the sub display screen 63 of the display portion being provided on the same side, in which the display portion of the sub display screen 63 is controllably switched between the display function and the illuminating function. The basic photographing operation is the same as that of the aforementioned example. Upon self-photographing, the user strikes a pose while viewing the subject image appearing on the sub display screen 63. The sub display screen 63 is set to fire a flash immediately before the start of the photographing operation. As described in Example 1, the camera may include a countdown display function.

As described above, the embodiments and the examples of the present invention provide a camera-equipped electronic device which includes a camera unit and at least one display portion. The display portion has an illuminating function for use in photographing, and provides good images in self-photographing and supports for a more compact device body while ensuring high visibility and capability of displaying an increased amount of information.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A camera-equipped electronic device comprising:
a camera unit having a lens portion; and
at least one display portion having a display screen,
wherein the lens portion of the camera unit and the display screen of the display portion are disposed on the same side of the device, the display portion being controllably switched between a display function and an illuminating function for illuminating a subject for use with camera unit.

2. The camera-equipped electronic device according to claim 1, wherein
the display function of the display portion serves as a finder for the camera unit.

3. The camera-equipped electronic device according to claim 1, wherein
the display function of the display portion serves as a function for displaying of photographing information which is displayed in response to photographing operation of the camera unit.

4. The camera-equipped electronic device according to claim 3, wherein
the photographing information is countdown information for signaling the start of photographing with the camera unit.

5. The camera-equipped electronic device according to claim 1, wherein
the illuminating function of the display portion serves as a flash illumination function which is enabled immediately before the start of photographing with the camera unit.

6. The camera-equipped electronic device according to claim 1, wherein
the illuminating function of the display portion is capable of selecting an emitted color.

7. The camera-equipped electronic device according to claim 1, wherein
the display portion is formed of an organic EL panel.

8. The camera-equipped electronic device according to claim 1, wherein
the camera-equipped electronic device is incorporated into an apparatus which also serves as a mobile phone.
